(19) United States
(12) Patent Application Publication
(10) Pub. No.: US 2022/0414627 A1
(43) Pub. Date: Dec. 29, 2022

(54) NEED-BASED AGGREGATE BILL PAYMENT SYSTEM

(71) Applicant: Wells Fargo Bank, N.A., San Francisco, CA (US)

(72) Inventors: Eric Greene, Piedmont, CA (US); Simone Harvey, Berkeley, CA (US); Adnan Khan, San Francisco, CA (US); Evelyn Ujanen, San Francisco, CA (US); Ajit Limaye, Portland, OR (US); Paul Vittimberga, Oakland, CA (US)

(21) Appl. No.: 15/582,312

(22) Filed: Apr. 28, 2017

(51) Int. Cl. G06Q 20/14; G06Q 20/22

(52) U.S. Cl. CPC G06Q 20/14; G06Q 20/29; G06Q 20/227

(57) ABSTRACT

A financial institution computing system includes a customer account database configured to retrievably store information pertaining to a plurality of financial accounts held by a plurality customers of the financial institution and a processing circuit. The processing circuit is configured to transfer a first amount of funds from a plurality customer financial accounts associated with a plurality of customers a pooling account, wherein the plurality of customers belong to a predetermined pooling group associated with the pooling account, identify a financial account associated with a paying customer, the paying customer having insufficient funds for a payment amount to a third party, and transfer a second amount of funds from the pooling account based on the payment amount to the financial account associated with the paying customer , wherein the paying customer belongs to the predetermined pooling group.

### TECHNICAL FIELD

The present disclosure relates to systems and methods for payment of customer bills.

### BACKGROUND

To receive payment for services provided to customers, service providers typically send individualized bills to customers. Periodic payment arrangements (e.g., weekly, monthly, etc.) where customers owe service providers an amount for services provided over a predetermined period are common. However, standard periodic payment arrangements can present issues for certain customers. For example, a particular customer may only have funds available to make a payment only after the due date of the payment. Such circumstances may lead to a late payment by the customer and the incurrence of late payment fees.

### SUMMARY

One embodiment relates financial institution computing system associated with a financial institution. The system includes a customer account database configured to retrievably store information pertaining to a plurality of financial accounts held by a plurality customers of the financial institution. The system also includes a processing circuit comprising a processor and memory, the memory structured to store instructions that are executable by the processor. The instructions cause the processor to transfer a first amount of funds from a plurality customer financial accounts associated with a plurality of customers to a pooling account, wherein the plurality of customers belong to a predetermined pooling group associated with the pooling account. The instructions also cause the processor to identify a financial account associated with a paying customer, the paying customer having insufficient funds for a payment amount to a third party. The instructions also cause the processor to transfer a second amount of funds from the pooling account based on the payment amount to the financial account associated with the paying customer , wherein the paying customer belongs to the predetermined pooling group.

Another embodiment relates to a method. The method includes transferring, by a processor a financial institution computing system associated with an financial institution, a first amount of funds from a plurality customer financial accounts associated with a plurality of customers to a pooling account, wherein the plurality of customers belong to a predetermined pooling group associated with the pooling account. The method also includes identifying, by the processor, a financial account associated with a paying customer, the paying customer having insufficient funds for a payment amount to a third party. The method also includes transferring, by the processor, a second amount of funds from the pooling account based on the payment amount to the financial account associated with the paying customer , wherein the paying customer belongs to the predetermined pooling group.

Another embodiment relates to a non-transitory computer readable media having computer-executable instructions embodied therein that, when executed by a processor of a financial institution computing system, causes the financial institution computing system to perform operations to transfer funds. The operations include transferring a first amount of funds from a plurality customer financial accounts associated with a plurality of customers to a pooling account, wherein the plurality of customers belong to a predetermined pooling group associated with the pooling account. The operations further include identifying a financial account associated with a paying customer, the paying customer having insufficient funds for a payment amount to a third party. The operations further include transferring a second amount of funds from the pooling account based on the payment amount to the financial account associated with the paying customer , wherein the paying customer belongs to the predetermined pooling group.

### BRIEF DESCRIPTION OF THE DRAWINGS

FIG. 1 is a block diagram of a diversified bill payment system, according to an example embodiment.

FIG. 2 is an exemplary diagram of a set of financial accounts associated with a customer, according to an example embodiment.

FIG. 3 is a flow diagram of a method of creating a customer payment pool, according to an example embodiment.

FIG. 4 is a flow diagram of a method of assigning a customer to a payment pool, according to an example embodiment.

FIG. 5 is a flow diagram of a method of using pooled customer funds to pay bills of customers having insufficient funds, according to an example embodiment.

FIG. 6 is a flow diagram of a method of monitoring a pooling arrangement, according to an example embodiment.

### DETAILED DESCRIPTION

Referring generally to the figures, various systems, methods, and apparatuses related to a diversified billing system structured to establish pooling platforms enabling customers of a financial institution to receive assistance in making timely payments to service providers are described.

According to various example embodiments, as described in further detail below, a diversified bill payment system establishes a pooling arrangement enabling customers to enter into pooling arrangements facilitates customers avoiding the late payment of bills owed to service providers. Unlike traditional arrangements, it is not necessary for the customer to ensure that the customer has adequate funds to make a timely payment to a service provider. Instead, using the system described herein, the customer's account balance at a financial institution is automatically updated using funds from other financial institution customers to ensure that the customer has sufficient funds to make a timely payment. At a later time, the customer provides funds to other customers (e.g., via a pool of funds) so that the other customers can make timely payments. Beneficially, this system enables customers of a financial institution to automatically assist one another in making timely payments to the service providers.

In addition, embodiments described herein solve the technical problem of stabilizing the amounts of customer payments to service providers over predetermined periods. This is addressed by forecasting the totality of payments required by service providers from the customer over a predetermined period, determining an incremental customer cost over a smaller period, requiring the customer to maintain a payment pooling account (herein referred to as a “pooling buffer account”) at the incremental customer cost, and ensuring that the totality of payments required by service providers are made in a timely fashion. This way, the customer can allocate a consistent amount of money to the payment of service providers despite variations in required payments.

An example implementation may be described as follows. A particular customer gets paid bi-monthly by an employer and has a series of payments (e.g., rent, utility bills, etc.) due at the beginning of the month. Unfortunately for the customer, the customer's first paycheck of the month is insufficient to make all of the payments due at the beginning of the month. Thus, the customer has a shortage of funds when the customer is required to make payments, and must make payments late after receiving the second paycheck of the month. The customer may incur late fees as a result. The contemplated diversified bill payment system is configured to group the customer with other customers into a pooling arrangement. For example, the system may group the customer with other customers having similar but differently timed fund deficiencies into a pooling arrangement. To illustrate, the customer may be paired with other customers lacking sufficient funds to make required payments due at the end of the month, but having sufficient funds at the beginning of the month. As another example, the customer may be grouped with other customers owing payments to similar service providers as the customer, being of a similar financial health as the customer, having similar bill due dates as the customer, and owing similar payment amounts to the service providers. Once the customer is assigned to a pooling arrangement, the contemplated diversified bill payment system is configured to update an account balance of the customer using funds from accounts of other customers in the customer's pool, thus providing the customer with sufficient funds to make timely payments at the beginning of the month.

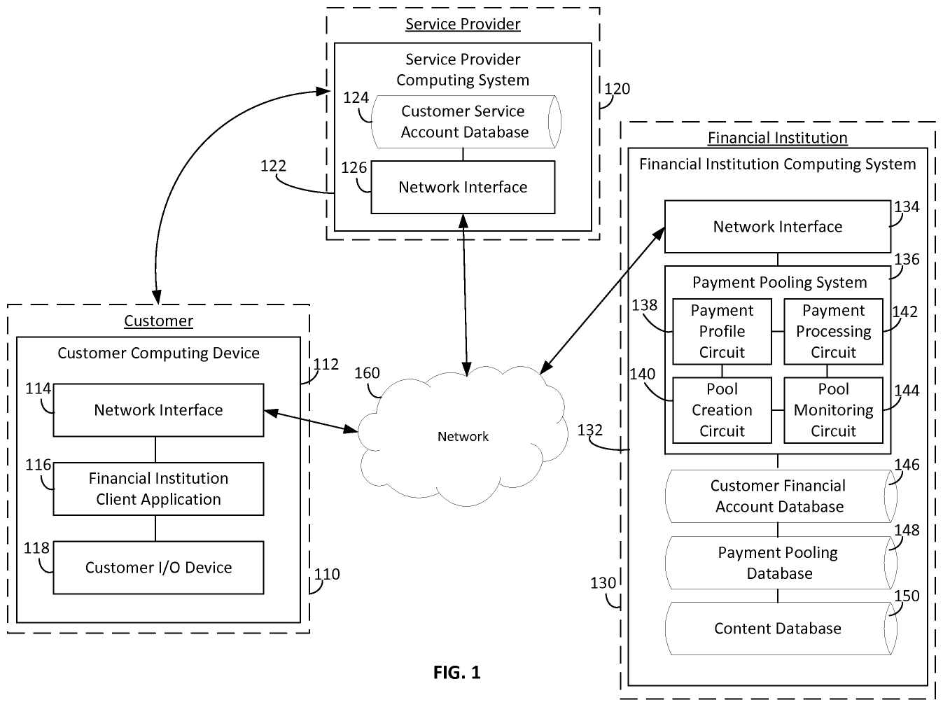

Referring now to FIG. 1, a block diagram of a diversified bill payment system 100 is shown according to an example embodiment. As will be described in further detail below, the diversified bill payment system 100 facilitates a customer 110 making timely payments to a service provider 120 for services provided by the service provider 120 to the customer 110 using an account held by the customer 110 at a financial institution 130. A financial institution computing system 132 associated with the financial institution 130 receives information pertaining to payment obligations of the customer 110 and is configured to assign the customer 110 to a pool with other customers having compatible payment obligations. As another example, the financial institution computing system 132 may assign the customer 110 to a pool based on various other criteria including, but not limited to the identity of the service provider 120, the financial health of the customer 110, the date that the payments to the service provider 120 are due, and the amount that the customer 110 owes to the service provider 120. The financial institution computing system 132 is also configured to update an account balance of an account held by the customer 110 at the financial institution 130 so that the customer 110 can make timely payments to the service provider 120 even if the account lacks sufficient funds to make the timely payments. For purposes of clarity, only one service provider 120 and customer 110 are shown. As will be understood, multiple service providers 120 and customers 110 may use the system 100 without departing from the scope of the present disclosure.

The customer 110 includes any customer of the financial institution 130 who is capable of incurring a payment obligation to a service provider 120. The customer 110 may include individuals and organizations (e.g., corporations, associations, and the like).The customer 110 has at least one account (e.g., a debit account, credit account, a checking account, etc.) at the financial institution 130 that may be used to make payments to the service provider 120.

The diversified bill payment system 100 includes a customer computing device 112 associated with the customer 110, a service provider computing system 122 associated with the service provider 120, and a financial institution computing system 132 associated with the financial institution 130, whereby these components are communicably coupled to each other over a network 160. The network 160 is a data exchange medium, which may include wireless networks (e.g., cellular networks, Bluetooth®, WiFi, Zigbee®, etc.), wired networks (e.g., Ethernet, DSL, cable, fiber-based, etc.), or a combination thereof. In some arrangements, the network 160 includes the Internet.

The customer computing device 112 is a computing device associated with the customer 110. The customer computing device 112 includes any type of computing device that may be used to conduct financial transactions and/or receive information from the financial institution computing system 132 or the service provider computing system 122. In some arrangements, the customer 110 uses the customer computing device 112 to both communicate information to service provider 120 over the network 160 as well as communicate information with the financial institution computing system 132. In this regard, the customer computing device 112 may include any wearable or non-wearable device. Wearable devices refer to any type of device that an individual wears including, but not limited to, a watch (e.g., smart watch), glasses (e.g., eye glasses, sunglasses, smart glasses, etc.), bracelet (e.g., a smart bracelet), etc. Customer computing device 112 may also include any type of mobile device including, but not limited to, a phone (e.g., smart phone, etc.), tablet, personal digital assistant, and/or computing devices (e.g., desktop computer, laptop computer, personal digital assistant, etc.).

In the example embodiment shown, the customer computing device 112 includes a network interface 114 enabling the customer computing device 112 to exchange information over the network 160, a financial institution client application 116, and a customer input/output (“I/O”) device 118. The customer I/O device 118 is configured to exchange information with the customer 110. An input device or component of the customer I/O device 118 allows the customer 110 to provide information to the customer computing device 112, and may include, for example, a mechanical keyboard, a touchscreen, a microphone, a camera, a fingerprint scanner, any user input device engageable with the customer computing device 112 via a USB, serial cable, Ethernet cable, and so on. An output device or component of the customer I/O device 118 allows the customer 110 to receive information from the customer computing device 112, and may include, for example, a digital display, a speaker, illuminating icons, LEDs, and so on.

The financial institution client application 116 is structured to provide displays to the customer computing device 112 that enable the customer 110 to manage financial accounts. Accordingly, the financial institution client application 160 is communicably coupled to the financial institution computing system 132 (e.g., the payment pooling system 136, the financial customer financial account database 146, or the payment pooling database 148). In some embodiments, the financial institution client application 116 may be incorporated with an existing application in use by the financial institution 130 (e.g., a mobile banking application or a mobile wallet application). In other embodiments, the financial institution client application 116 is a separate software application implemented on the customer computing device 112. The financial institution client application 116 may be downloaded by the customer computing device 112 prior to its usage, hard coded into the memory of the customer computing device 112, or be a web-based interface application such that the customer computing device 112 may provide a web browser to the application, which may be executed remotely from the customer computing device 112. In the latter instance, the customer 110 may have to log onto or access the web-based interface before usage of the applications. Further, and in this regard, the financial institution client application 116 may be supported by a separate computing system including one or more servers, processors, network interface circuits, etc. that transmit applications for use to the customer computing device 112. In certain embodiments, the financial institution client application 116 includes an API and/or a software development kit (SDK) that facilitate the integration of other applications with the financial institution client application 116. For example, financial institution client application 116 may include an API that facilitates the receipt of information pertaining to payments due to the service provider 120 to facilitate the processes described below.

The displays presented to the customer 110 via the financial institution client application 116 may be indicative of current account balances, pending transactions (e.g., payments to service provider 120), profile information (e.g., contact information), and the like. Further, in some embodiments, the financial institution client application 116 is also structured to present displays pertaining to a payment pooling program. For example, the financial institution client application 116 is configured to present the customer 110 with a display that gives the customer 110 the ability to indicate a preference to sign up for a payment pooling program implemented by the financial institution computing system 132. In some arrangements, the customer 110 is presented with displays allowing the customer 110 to input parameters of various payments owed by the customer 110 to the service provider 120. Payment parameters may include, for example, due dates for various payments, payment amounts, and the like.

Service provider computing system 122 is a computing system associated with a service provider 120. The service provider 120 may be any entity which engages in any sort of transaction with the customer 110. In some arrangements, the service provider 120 includes an entity that receives periodic payments from the customer 110 in exchange for providing a continuous service to the customer 110 (e.g., utilities, housing, content delivery, etc.). Service provider computing system 122 includes a network interface 124 enabling the service provider computing system 122 to exchange data over the network 160, and a customer account database 126.

The customer account database 126 is a storage device that is structured to retrievably store information pertaining to customer service usage and payments, and may include non-transient data storage mediums (e.g., local disc or flash-based hard drives, local network servers, and the like) or remote data facilities (e.g., cloud servers). The customer account database 126 includes personal customer information (e.g., names, addresses, phone numbers, and so on), identification information, customer service information (e.g., identifying a particular service that the service provider 120 provides to the customer 110), and customer payment information (e.g., customer payment due dates, historical customer payment data, etc.).

In some arrangements, the service provider computing system 122 includes a processor and memory (not shown) storing logics executable by the processor that configure the processor to exchange information with the customer computing device 112 over the network 160. In some arrangements, the information exchanged over the network 160 includes information pertaining to payments owed by the customer 110 to the service provider 120 (e.g., payment amount, due date). In some arrangements, the customer computing device 112 includes an application integrated into the financial institution client application 116 that enables the customer 110 to view the information transmitted by the service provider computing system 122 to the customer computing device 112 (e.g., via a display device included in the customer I/O device 118).

The financial institution computing system 132 is a computing system associated with a financial institution 130 that implements a payment pooling program enabling the customer 110 to make timely payments to the service provider 120. The financial institution 130 may include commercial or private banks, credit unions, investment brokerages, or the like. The financial institution computing system 132 includes a network interface 134, a payment pooling system 136, a customer financial account database 146, a payment pooling database 148, and a content database 150. The network interface 134 is configured to facilitate the communication of the financial institution computing system 132 with external computing devices (e.g., customer computing devices 112 or the service provider computing system 122) over the network 160.

The content database 150 is a storage device structured to retrievably store content related to the various operations discussed herein that may be transmitted to various customers 110, and may include non-transient data storage mediums (e.g., local disc or flash-based hard drives, local network servers, and the like) or remote data storage facilities (e.g., cloud servers). The content database 150 includes content that instructs various customers 110 registered for the payment pooling programs described herein on ways to avoid situations where they are unable to make timely payments to service provider 120. For example, the content database 150 may include content describing various savings programs offered by the financial institution 130 that allow customers 110 to set money aside for making payments to service provider 120. In some arrangements, the content database 150 also includes information that instructs customers 110 on how to formulate a budget allocating an amount towards paying the service provider 120 each month.

The customer financial account database 146 is a storage device structured to retrievably store customer information relating to the various operations discussed herein, and may include non-transient data storage mediums (e.g., local disc or flash-based hard drives, local network servers) or remote data storage facilities (e.g., cloud servers). The customer financial account database 146 includes personal customer information (e.g., names, addresses, phone numbers), identification information (e.g., driver license numbers, standard biometric data), and customer financial information (e.g., token information, account numbers, account balances, available credit, credit history, transaction histories, and so on). In some arrangements the customer financial account database 146 is configured to store information pertaining to customer relationships with the service provider 120. For example, the customer 110 may have an arrangement with a particular service provider 120 whereby the service provider 120 (e.g., a utility company) provides a service to the customer 110 and the customer 110 makes periodic (e.g., monthly) payments to the service provider 120. The customer financial account database 146 may include a history of the relationship between the customer 110 and the service provider 120 including past payments made by the customer 110 to the service provider 120 (e.g., payment amounts, payment due dates, payment times).

The payment pooling database 148 is a storage device structured to retrievably store customer information relating to the various operations discussed herein, and may include non-transient data storage mediums (e.g., local disc or flash-based hard drives, local network servers, and the like) or remote data storage facilities (e.g., cloud servers). In some arrangements, the payment pooling database 148 stores information pertaining to various pooling arrangements that payment pooling system 136, using methods to be described below, has established between the customer 110 and other customers of the financial institution 130. Such information may identify various customers and/or accounts associated with the customers who have agreed to participate in the payment pooling program implemented by the payment pooling system 136. In some arrangements, the payment pooling database 148 is configured to keep track of various transfers of funds to and from various customer accounts in payment pooling arrangements to be discussed below. The payment pooling database 148 stores information pertaining to available customer funds for pooling and information concerning upcoming payments owed by various customers 110 to the service provider 120.

The payment pooling system 136 is configured to manage a payment pooling program for the customer 110. In this regard, the payment pooling system 136 is configured to receive information input by the customer 110 into the customer computing device 112, retrieve other customer information stored in the customer financial account database 146, identify customer relationships with the service provider 120, identify customers who are unable to make timely payments to service provider 120, group customers 110 together based on the identified customer relationships with the service provider 120, establish pooling buffer accounts for various customers 110, and facilitate the exchange of funds between various customer accounts and the service provider 120. Accordingly, the payment pooling system 136 is communicatively coupled with the network interface 134, the customer financial account database 146, the payment pooling database 148, and the content database 150.

As shown, the payment pooling system 136 includes a payment profile circuit 138, a pool creation circuit 140, a payment processing circuit 142, and a pool monitoring circuit 144. Further, in some arrangements, activities of one circuit may be combined with the activities of another circuit, thus, the depiction and explanation contained herein is for exemplary purposes only.

The payment profile circuit 138 is configured to determine cash flow patterns of various customers. In some arrangements, the payment profile circuit 138 determines characteristics of customer relationships to the service provider 120. For example, in one embodiment, the payment profile circuit 138 determines the total amount of payments made by the customer 110 to service provider 120 over a predetermined period. In this regard, the payment profile circuit 138 is configured to retrieve the customer's transaction history from the customer financial account database 146, identify payments made by the customer 110 to the service provider 120, and perform various operations on the customer's payment information. Operations performed by the payment profile circuit 138 may include aggregating all of the payments made by the customer 110 to the service provider 120, determining an average payment amount of the customer 110 over a predetermined period (e.g., monthly), and determining the timing of the customer's payments.

In some arrangements, the payment profile circuit 138 is configured to detect variations in customer payments to the service provider 120 that are indicative of the customer 110 making late payments to the service provider 120. For example, the payment profile circuit 138 may determine that a customer 110 has made a late payment to a service provider 120 if the customer 110 makes a payment that is greater than previous payments (e.g., by more than a predetermined threshold) made by the customer 110 to that service provider 120. Alternatively or additionally, the timing of the payment may be taken into account in identifying a late customer payment. For example, if the customer 110 previously made payments to the service provider 120 at a first day of the month, and the payment profile circuit 138 identifies a payment at a second day of the month after the first day, the payment profile circuit 138 may identify that payment as a late payment. In some embodiments, the payment profile circuit 138 retrieves due dates for customer payments from the customer financial account database 146. In some embodiments, the payment profile circuit 138 is also configured to receive information regarding the due dates of upcoming customer payments directly from the customer 110 (e.g., in the registration process described below).

In some arrangements, the payment profile circuit 138 is configured to determine when the customer 110 has funds available to make payments to the service provider 120. For example, in some arrangements, the payment profile circuit 138 is configured to assess customer account balance information stored in the customer financial account database 146 to determine the timing and amount of positive customer cash flows (e.g., the timing of a direct deposit made by an employer of a customer 110). In some arrangements, the payment profile circuit 138 is configured to determine whether there is a mismatch between when the customer 110 has funds available and when customer payments to service provider 120 are due. For example, the payment profile circuit 138 may aggregate the amount of all of upcoming payments of the customer 110 that are due by a certain date and compare the aggregate amount to customer account balance information at that date. If the customer account balance is below the aggregate payment amount (e.g., the customer has an account deficiency), the payment profile circuit 138 determines the timing of the next forecasted positive cash flow of the customer (e.g., based on previous positive account balance changes) and determines if the next positive cash flow is sufficient for the customer 110 to make the due payments (e.g., to create an account surplus).

In some arrangements, based on the totality of payments that the customer 110 makes to the service provider 120, the payment profile circuit 138 is configured to determine an average amount that the customer 110 pays over a predetermined period. For example, for each service provider 120 that the customer 110 has made payments to over the previous year, the payment profile circuit 138 may determine an average monthly payment. The average monthly payments made to each service provider 120 may then be aggregated to produce a total monthly average payment of the customer 110.

In some arrangements, based on the total monthly average payment and other information (e.g., such as customer income, biographical information, and the like), the payment profile circuit 138 is configured to generate a pooling buffer amount for the customer 110. The pooling buffer amount may be a portion of the customer's account balance that is placed into a shadow account (herein called the “pooling buffer account”) associated with the customer 110. Pooling buffer accounts may be maintained in the customer financial account database 146 and stored in association with a set of buffer rules that restrict the customer 110's access to funds placed in the pooling buffer account. For example, in various arrangements, funds placed in the pooling buffer account may only be used to make payments to service provider 120 or transferred to a payment pool for user by other customers 110 of the financial institution 130 to make payments to service provider 120. In some arrangements, the buffer rules associated with each pooling buffer account may be particularized to each customer 110. For example, in one embodiment, customers 110 may be granted access to varying percentages of funds in their pooling buffer accounts depending on various factors, such as the pooling buffer amount selected for each customer (e.g., a customer having a higher pooling buffer amount may be granted access to a greater percentage of funds placed in the pooling buffer account).

In some arrangements, the payment profile circuit 138 is configured to generate a risk score for the customer 110. When referred to herein, the term “risk score” refers to a rating system based on predetermined parameters set by the financial institution 130. The risk score may be based off on a number of factors. For example, the risk score may be based on the total amount in payments owed by the customer 110 to the service provider 120. Customers tending to have greater amounts of payments due to the service provider 120 may tend to receive higher user risk scores than those who tend to have lower amounts in due payments. Additionally, the variability in the customer 110's account balance information in the customer financial account database 146 may impact the risk score. A particular customer 110 whose account balance consistently shifts from being above a first threshold (e.g., $1000) to below a second threshold (e.g., $200), for example, may tend to receive a higher risk score than another customer 110 whose account balance consistently stays above a third threshold (e.g., $400). In some arrangements, the risk score may also be tied to characteristics of the income of a particular customer 110. For example, a customer 110 whose account balance receives consistent and frequent funds (e.g., via a direct deposit) may tend to receive a lower risk score than another customer 110 whose account receives less consistent funds (e.g., the customer 110 manually deposits inconsistent amounts in the account).

In some arrangements, the payment profile circuit 138 determines a risk score for the customer 110 using a predetermined formula taking into account the various factors discussed above. For example, in one embodiment, the payment profile circuit 138 compares account balance characteristics to a baseline set of characteristics to generate the risk score. In this example, the risk score may range from zero to two, with two being associated with a maximum-risk customer and zero being associated with a minimal risk customer. The baseline set of characteristics may be associated with a risk-neutral customer, and may designate a total average amount owed by the risk-neutral customer to the service providers over the course of a month, an average account balance of the risk-neutral customer over the course of a month, the average time interval between positive account transactions (e.g., deposits) of the risk-neutral customer, and so on. As such, if a particular customer 110 owes an average amount of $1,000 to the service provider 120 over the course of a month, and the baseline characteristic of a risk-neutral customer is $500, the payment profile circuit 138 may generate a risk score of two for the customer 110 as to the amount owed. A similar procedure is performed for the other characteristics of the customer 110's account balance information, and a total risk score may be the average of the score for each of the individual characteristics.

The pool creation circuit 140 is configured to generate payment pools of customer funds that may be used to make payments to the service provider 120. In some arrangements, the pool creation circuit 140 is configured to identify a set of customers having aggregate financial data that meets predetermined parameters set by the financial institution 130. For example, in some arrangements, the pool creation circuit 140 is configured to identify a group of customers that, in combination, has a neutral set of cash flows within a threshold. In this regard, the pool creation circuit 140 identifies a set of customers based on the payment profiles generated for each customer by the payment profile circuit 138. As discussed above, the payment profile circuit 138 determines the timing of customer account deficiencies (e.g., times when the customer 110 lacks sufficient funds to make upcoming payments due to the service provider 120) and customer account surpluses (e.g., when the customer 110 has more than enough funds available to make required payments to the service provider 120). Accordingly, the pool creation circuit 140 may be configured to identify various groups of customers having total account deficiencies and surpluses that offset one another at various times. As used herein, the term “total account deficiencies” and “total account surpluses” refers to the difference between the aggregate of payments owed by the customers 110 in a group of customers to the service provider 120 and the aggregate of the respective account balances of the customers 110. When the difference is positive (i.e., when the total amount in payments owed is greater than the aggregate account balance), the group possesses a “total account deficiency.” When the difference is negative (i.e., when the total amount in payments owed is less than the aggregate account balance), the group possesses a “total account surplus.”

In an illustrative example, the pool creation circuit 140 identifies a first group of customers 110 that, in the aggregate, tends to have a total account deficiency of a first amount (e.g., $100,000) prior to the middle of the month and an account surplus of the first amount after the middle of the month. In this example, the pool creation circuit 140 also identifies a second group of customers 110 that, in the aggregate, tends to have a total account surplus of the first amount prior to the middle of the month and an account deficiency of the first amount after the middle of the month. Thus, when combined, the first group and the second group of customers has a neutral total account balance for each month. The pool creation circuit 140 then establishes a pooling arrangement between the customers of the first group and the second group whereby, using methods described below, funds from the pooling buffer of each customer 110 may be used by other customers to make payments to the service provider 120. In some arrangements, the pool creation circuit 140 is configured identify a group of customers that have offsetting risk characteristics. For example, in one embodiment, the pool creation circuit 140 is configured to identify a group of customers having a predetermined average risk score. In this regard, the pool creation circuit 140 identifies the risk score assigned to each customer by the payment profile circuit 138 and identifies a group of customers having the predetermined average risk score.

In some embodiments, the pool creation circuit 140 first selects groups of customers for the payment pooling program based on predetermined parameters. Such parameters may be established by the financial institution 130. For example, the financial institution 130 may set up a series of qualifications for a particular pool. Qualifications may include, for example, account balance thresholds, other indicators of overall financial health (e.g., home ownership, credit scores), account balance patterns (e.g., timing of deposits into customer accounts, account balance trends), payment amount thresholds (e.g., limitations on the total amount in payments that the customer 110 may owe to the service provider 120 and other service providers), and payment timing thresholds (e.g., the due dates of payments owed to the service provider 120). The pool creation circuit 140 may identify various groups of customers by adjusting the parameters and combine the identified groups into a pooling arrangement. In one example, the pool creation circuit 140 identifies a first group of customers based on a first set of criteria and a second set of customers based on a second set of criteria. The first set of criteria may specify a first total payment amount and a first range of dates for the payments. The second set of payment criteria may specify a second total payment amount and a second range of dates for the payments. The pool creation circuit 140 identifies the first group of customers meeting the first set of criteria and the second set of customers meeting the second set of criteria based on the profiles generated by the payment profile circuit 138. As such, the financial institution 130 is able to specifically tailor the composition of various payment pools based on any set of predefined parameters.

Having identified a group of customers with which to form a pool, the pool creation circuit 140 is configured to facilitate the registration of customers 110 to a payment pooling program implemented by the payment pooling system 136. For example, after determining that a particular customer 110 may benefit from a payment pooling arrangement, the pool creation circuit 140 may be configured to transmit registration content to the customer computing device 112 over the network 160 via the network interface 134 enabling the customer 110 to register for the reward pooling program. In an example, if the pool creation circuit 140 identifies the customer 110 as a potential pooling participant, the pool creation circuit 140 transmits a registration interface to the customer computing device 112. The registration interface may describe the payment pooling program to the customer 110 and enable the customer to provide an input to register for the program.

Upon the customer 110 providing such an input, the pool creation circuit 140 may transmit various other interfaces to the customer 110 enabling the customer 110 to provide various other inputs. For example, the pool creation 140 may identify a recurring payment owed by the customer 110 to the service provider 120 (e.g., based payment profile generated by the payment profile circuit 138) and present the customer 110 with an interface configured to receive a customer input to include the recurring payment in the customer 110's enrollment in the program. In one embodiment, the interfaces also allow the customer 110 provide similar inputs regarding other payments owed to various other service providers identified by the payment profile circuit 138.

Additionally, the interfaces may include various calculations performed by the payment profile circuit 138. In an example, such additional interfaces may identify an average monthly amount paid by the customer to the service provider 120 and to other service providers and the pooling buffer amount discussed above. The pooling buffer amount may be updated based on previous inputs received from the customer 110 (e.g., inputs regarding a preference to include a payment in the customer 110's enrollment). For example, if the customer 110 chooses to not include the payment to the service provider 120 in the customer 110's enrollment in the payment pooling program, the pooling buffer amount may be decreased by an amount corresponding to the payment. In some embodiments, the interfaces may prompt the customer 110 to permit the financial institution 130 to establish the pooling buffer account and notify the customer 110 of restrictions on the customer's access to the funds placed into the pooling buffer account once it has been established. In some embodiments, the interfaces enable the customer 110 to provide a preference as to the pooling buffer amount. For example, the customer 110 may be able to adjust the pooling buffer amount upwards or downwards from the amount calculated by the payment profile circuit 138 by a predetermined amount (e.g., a fixed percentage of the calculated pooling buffer amount).

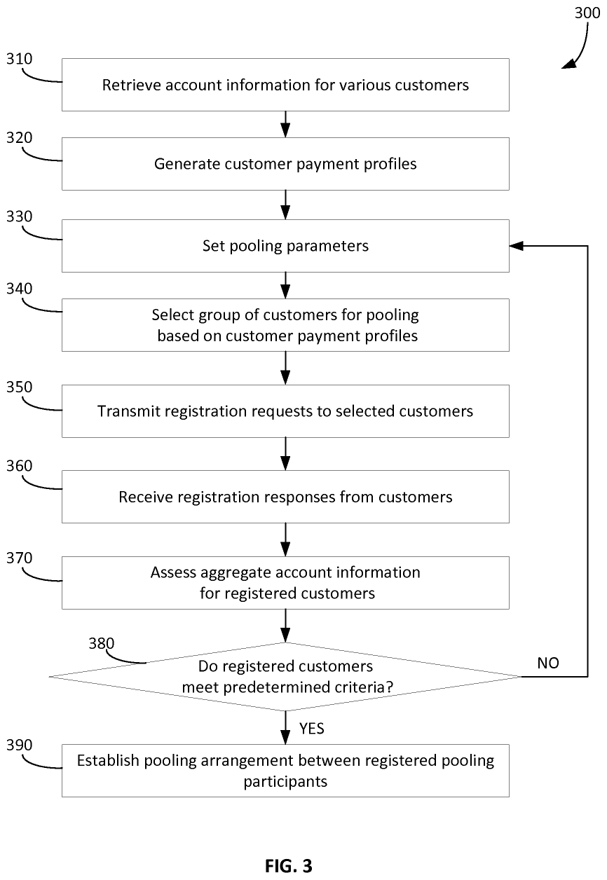

Having received registration responses from various customers 110, the pool creation circuit 140 establishes pooling buffer accounts for each of the customers 110 who registered for the program, and a general pooling account. As used herein, the term “general pooling account” is an account associated with a pooling arrangement between various customers 110 established by the pool creation circuit 140. The general pooling account is funded using funds from the pooling buffer accounts of the customers 110 associated with the pooling arrangement. A diagram illustrating the arrangements of the various accounts is shown in FIG. 3.

The payment processing circuit 142 is configured to maintain a pool of funds that may be used by various customers 110 to make timely payments to the service provider 120 and to process payments to the service provider 120. In some arrangements, the payment processing circuit 142 creates a pool of funds by monitoring account balance information for various customers 110 in a pooling arrangement created by the pool creation circuit 140. For example, at predetermined times, or responsive to the pooling buffer account balance of the customer 110 reaching a predetermined threshold, the payment processing circuit 142 may be configured to transfer a predetermined amount of customer funds from the primary customer account at the financial institution 130 to the pooling buffer account created for the customer 110 by the payment profile circuit 138.

In some arrangements, customer funds transferred to the customer pooling buffer account may only be used for payments owed by the customer 110 to the service provider 120 or transferred to the general pooling account. In this regard, the payment processing circuit 142 is configured to identify upcoming payments owed by the customer 110 to the service provider 120 and determine a total amount of upcoming customer payments that are due within a predetermined time. For example, for a particular customer 110, the payment processing circuit 142 may identify all customer payments that are due within the next two-week-period and compare the total amount of such payments to the amount of funds in the customer pooling buffer account. If the amount of funds in the pooling buffer account exceeds the total amount of upcoming due payments, the payment processing circuit 142 transfers the excess of funds to the general pooling account. If, however, the amount of funds in the pooling buffer is lower than the amount of upcoming due payments, the payment processing circuit 142 quantifies the deficiency and transfers funds from the general pooling account to the pooling buffer of the customer 110 so that the customer 110 can make the upcoming payments owed to the service provider 120.

Having ensured that the customer 110 has sufficient funds in the pooling buffer account to make the upcoming payments, the payment processing circuit 142 is also configured to process payments to the service provider 120. In an example, the payment processing circuit 142 may automatically transfer funds to an account associated with the service provider 120 (e.g., to an acquiring bank via a card network computing system) prior to the due date of the upcoming payment. In another example, the payment processing circuit 142 may transmit a push notification to the customer computing device 112 identifying the payment. The notification may be configured to receive a customer input to complete the payment. Upon receipt of such an input, the payment processing circuit 142 may deduct the funds from the customer 110's pooling buffer account. The specific steps taken by the payment processing circuit 142 to process the payment may depend on a preference given by the customer during the registration process described herein.

The pool monitoring circuit 144 is configured to track the various operations performed by the payment processing circuit 142. For example, in some arrangements, the pool monitoring circuit 144 is configured to monitor the set of customers 110 that participate in the pools created by the pool creation circuit 140 to determine that the pools maintain conformance with various parameters set by the financial institution 130. As discussed above, a particular group of customers 110 may be selected for a particular pool because the aggregate cash flows associated with the customers 110 within the group have desired characteristics (e.g., aggregate neutrality to a threshold). In such an arrangement, it may be necessary to ensure that the group of customers 110 in an established pool maintains the desired characteristics. For example, certain customers 110 may wish to no longer participate in the pooling program and unregister for the program. Additionally, customers 110 may alter the services that they receive from the service provider 120, and thus change their account balance information, which may impact the aggregate cash flows of the group. Accordingly, in one embodiment, the pool monitoring circuit 144 monitors the activity of the customers 110 within a pool, determines the impact of the customer activity on the characteristics of the aggregate cash flows of the group of customers 110 that make up the pool, and takes actions responsive to the impacts.

For example, a first subset of customers within a pool may sign up for additional or more costly services offered by the service provider 120 or other service providers. Such an action may de-neutralize the aggregate cash flows of each of the customers 110 within the pool. In other words, the timing and amount of additional payments owed by the first subset of customers as a result of signing up additional services may lead to a deficit in the general pooling fund associated with the pool. To illustrate, if a large portion of the additional payments incurred by the first subset of customers are due prior to the middle of the month, this may lead to insufficient funds in the pool at the beginning of the month to make the required payments. Accordingly, the pool monitoring circuit 144 may take certain actions responsive to detecting such a situation. The pool monitoring circuit 144 may require the first subset of customers to provide additional funding into their pooling buffer accounts. Additionally, the pool monitoring circuit 144 may also begin a process to register additional customers to the pool that have cash flows that tend to offset the additional services registered for by the existing customers in the pool.

In some arrangements, the pool monitoring circuit 144 is configured to monitor the pooling buffer accounts of the respective customers 110 in a pool. In some arrangements, the pool monitoring circuit 144 measures the time that has lapsed since funds have been placed in a pooling buffer account associated with a particular customer 110 and automatically transfers funds from a primary financial account (e.g., a checking account) associated with the customer 110 to the pooling buffer account. In some arrangements, the pool monitoring circuit 144 determines the amount of funds in the pooling buffer account of each customer 110 in a pool and compares the amount with various thresholds. If, for example, the amount of funds in the buffer account of a particular customer 110 is above a predetermined threshold, the pool monitoring circuit 144 may transfer funds from the pooling buffer account to the primary account of the customer 110. Alternatively, if the amount of funds in the buffer account of a particular customer is below a predetermined threshold, the pool monitoring circuit 144 may determine whether the customer 110 has an upcoming deposit scheduled for the pooling buffer account (e.g., set by the pooling parameters generated for the customer 110 via the payment profile circuit 138). If there is no upcoming deposit, the pooling monitor may be configured to transfer funds from the general account of the customer 110 to the pooling buffer, or to request funds from the customer 110.

In some arrangements, the pool monitoring circuit 144 monitors the pooling activity of customers 110 and transmits content stored at the content database 150 to the customer computing device 112 when certain triggers are detected. For example, each time that funds are transferred into the pooling buffer account of a particular customer 110, the pool monitoring circuit 144 creates a data entry in a dataset stored in association with the customer's account in the financial account database 146. Each entry identifies a timing and amount of a transfer into the customer 110's account. If the funds are transferred into the customer's pooling buffer account meet a predetermined threshold (i.e., the amount of funds transferred from the general pooling account to the pooling buffer account is above a predetermined threshold), for example, the pool monitoring circuit 144 may retrieve content from the content database 150 and transmit the retrieved content to the customer computing device 112 over the network 160. The pool monitoring circuit 144 may also transmit content if the customer's pooling buffer account or primary financial account drops below a predetermined threshold. The transmitted content 110 may inform the customer about ways to budget funds towards making payments to the service provider 120. For example, the content may inform the customer of an amount that the customer 110 should be paying to service provider 120 given the income of the customer 110. Information regarding customer payments to the service provider 120 may also be retrieved from the account database 146, and the transmitted content may provide the customer 110 with a list of all of the payments that the customer 110 is making to assist the customer 110 in identifying any unnecessary services being paid for.

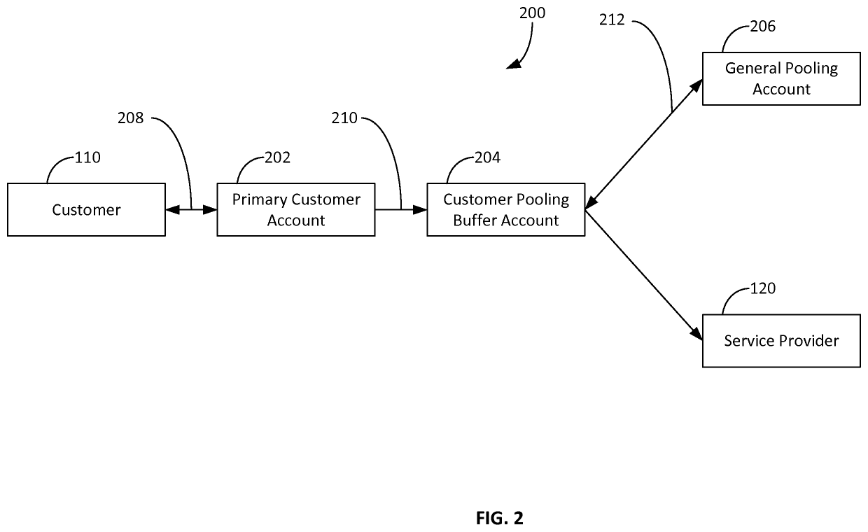

Referring now to FIG. 2, a block diagram of a set 200 of accounts associated with a customer 110 is shown, according to an example embodiment. While the set 200 is shown only to relate to a single customer 110 is should be understood that each customer 110 in a pool established by the methods disclosed herein may having a set that is similar to the set 200. The set 200 includes a primary customer account 202, a customer pooling buffer account 204, and a general pooling account 206. The primary customer account 202 may be any type of account held by the customer 110 at the financial institution 130 from which the customer 110 may transfer funds. As such, the primary customer account 202 may include, among other types of accounts, a checking account, a savings account, a credit account, a rewards account, a health savings account, an investment account, an individual retirement account, a loyalty account, and a gift card account. As indicated by the bidirectional arrow 208, in some embodiments, the customer 110 may both deposit and withdraw funds into and out of the primary customer account 202. The customer pooling buffer account 204 is the account established for the customer 110 by the pool creation circuit 140 once the customer 110 registers for the pooling program offered by the financial institution 130. As indicated by the unidirectional arrow 210 between the customer pooling buffer account 204 and the primary customer account 202, in the example shown, funds may only be transferred from the primary customer account 202 into the customer pooling buffer account 204. In other words, in the example shown, the customer 110 may not remove funds from the customer pooling buffer account 204 into the primary customer account 202.

The set 200 further includes general pooling account 206. The general pooling account 206 is established by the pool creation circuit 140 when a pooling arrangement is established between a group of customers 110 via the methods described herein. In the example shown, funds may be transferred both to the general pooling account 206 from the customer pooling buffer account 204 and from the general pooling account 206 to the customer pooling buffer account 204, as indicated by the bidirectional arrow 212. As such, the systems and methods disclosed herein may transfer funds from the customer pooling buffer account 204 to the general pooling account 206 when the pooling buffer account 204 has an account surplus (e.g., when upcoming payments owed by the customer 110 to the service provider 120 are less than the current balance of the customer pooling buffer account 204). Additionally, the systems and methods disclosed herein may transfer funds from the general pooling account 206 to the customer pooling buffer account 204 when the pooling buffer account has an account deficiency (e.g., upcoming payments owed by the customer 110 to the service provider 120 are more than the current account balance of the customer pooling buffer account 204). Funds in the customer pooling buffer account 204 may be transferred to the service provider 120 such that the customer 110 makes timely payments to the service provider 120.

Referring now to FIG. 3, a flow diagram of a method 300 of selecting a group of customers 110 to form a payment pool is described according to an example embodiment. The method 300 may be performed by the components of FIG. 1, such that references may be made to one or more components of FIG. 1 to aid in the description of the method 300.

Customer account information is received at 310. In various arrangements, the payment pooling system 136 (e.g., via the payment profile circuit 138) retrieves account information from the customer financial account database 146 concerning one or more customers 110. In one embodiment, the retrieved customer information includes customer transaction information, customer account balance information, and the like. The retrieved customer transaction information may include information concerning various previous payments made by the customers 110 to the service provider 120. Additionally, the customer transaction information also includes information concerning various withdrawals and deposits made by various customers 110 into their respective accounts at the financial institution 130.

Customer payment profiles are generated at 320. As discussed above, the payment pooling system 136 (e.g., via the payment profile circuit 138) is configured to generate a payment pooling profile for a customer 110 depending on the relationship between the customer 110 and the service provider 120. A particular payment profile identifies or projects the timing of various customer account events. For example, in one embodiment, a payment profile includes the average total amount of payments made by a particular customer 110 to the service provider 120 over the course of a month. The payment profile may also identify the timing of payments made by a customer 110 to the service provider 120. In generating the payment profile for a particular customer 110, the payment profile circuit 138 may also determine the historical timing of local maximums and minimums of the customer 110's account balance and project the customer 110's account balance at various times (e.g., daily) within the month. The customer 110's projected account balance is then compared with the total amount of payments owed by the customer 110 to the service provider 120 at various times of the month to determine when the customer 110 has potential account surpluses (e.g., a higher projected account balance than payments due) and deficiencies (e.g., a lower projected account balance than payments due). The payment profile generated for the customer 110 may include the timing and amount of customer account surpluses and deficiencies. Additionally, the payment profile may include risk characteristics (e.g., the risk score discussed above) of the customer 110 as discussed above.

Pooling parameters for a particular pool are set at 330. In some arrangements, pooling parameters include a set of qualifications that a customer 110 must meet to be eligible to participate in the payment pooling program run by the financial institution 130. Pooling parameters may specify certain payment thresholds. For example, in one embodiment, if a customer 110 has a total amount of payments due to the service provider 120 over the course of a month that exceeds a predetermined threshold, the customer 110 is not eligible to participate in payment pooling. In some embodiments, payment pooling parameters may specify minimum account balance thresholds such that, if a customer 110 has a tendency to reduce the balance of an account held by the customer 110 at the financial institution 130 below a predetermined threshold, the customer 110 is ineligible for pooling. In some embodiments, the pooling parameters may set timing requirements for customer account information. For example, the pooling parameters may specify a minimum average amount of time that the customer account balance must be above a specified threshold each month.

A group of customers is selected for pooling at 340. In some arrangements, the payment pooling system 136 (e.g., via the pool creation circuit 140) is configured to filter out the various customers having account information that is incompatible with the pooling parameters set at 330. For example, customers having total payment obligations to the service provider 120 or account balance trends not meeting various parameters may be disqualified from participating in a pooling program.

In some arrangements, based on the payment profiles generated at 320, the payment pooling system 136 (e.g., via the pool creation circuit 140) is configured to identify a group of customers 110 for a pool having aggregate cash flows meeting predetermined criteria at 340. In this regard, the payment pooling system 136 identifies a plurality of groups of customers 110, with each customer 110 in each group having similar cash flow characteristics. The groups may be identified based on the timing and amount of account surpluses and deficiencies in the payment profiles generated at 320. For example, in one embodiment, the pool creation circuit 140 identifies a first group of customers 110 that is projected to have an aggregate deficiency at a first time in the month, but have an aggregate surplus at a second time of the month. After selecting the first group of customers, the pool creation circuit 140 may identify a second group of customers 110 that is projected to have an aggregate surplus at the first time in the month that at least offsets the deficiency of the first group of customers 110. Depending on the timing and amount of any deficiency that is projected for the second group, and the relationship between that deficiency and the surplus of the first group, additional groups may be selected to mitigate any deficiencies of the second group. This process may be repeated until the entire group of customers 110 in the pool (e.g., including the first group, the second group, and any other group) is projected to produce a more or less neutral set of cash flows throughout a predetermined period. In some arrangements, the group of customers 110 is selected based on the risk characteristics of each customer 110, as generated by the payment profile circuit 138 discussed above.

Registration requests are transmitted to the selected customers at 350. In some arrangements, the payment pooling system 136 (e.g., via the pool creation circuit 140), is configured to notify the customers selected at 340 of the payment pooling program offered by the financial institution 130. The notification takes the form of a push notification, viewable by via the selected customers 110 via the customer computing device 112 (e.g., via the financial institution client application 116). In some arrangements, the notification may include a registration interface enabling the selected customers 110 to indicate whether they wish to participate in the payment pooling program. Additionally, the registration interface may also enable the customers 110 to input information pertaining to payments owed to the service provider 120.

Registration responses are received at 360. In various arrangements, the payment pooling system 136 (e.g., via the pool creation circuit 140) is configured to receive data describing customer interactions with the registration interfaces (e.g., via the financial institution client application 116) transmitted at 350. The data may describe customer preferences to participate in the payment pooling program and describe various payment obligations that the customers 110 have to the service provider 120 (e.g., beyond what is detailed by the information stored in the customer financial account database 146).

The aggregate account information of the customers who registered for the pooling program is assessed at 370. In various arrangements, if not all of the selected group of customers 110 for the pool elects to participate in the payment pooling program, the group of customers 110 that elected to participate in the program may not have an aggregate set of cash flows that meets the predetermined criteria discussed above. Accordingly, the payment pooling system 136 is configured to identify the customers 110 who were sent registration requests at 350 who indicated a preference to register for the payment pooling program, aggregate the financial data for the registered customers 110 stored in the customer financial account database 146, and perform various operations on the aggregated data. Operations include, for example, determining the due dates for payments owed by the registered customers 110 and determining the timing of account surpluses or deficiencies of the registered customers 110.

It is determined if the registered customers 110 meet predetermined criteria at 380. In some arrangements, the payment pooling system 136 is configured to determine the timing of aggregate account surpluses and deficiencies amongst various groups of registered customers 110 to determine if the aggregate cash flows of the registered customers meet the predetermined criteria set by the financial institution 130.

If the aggregate financial data of the registered customers 110 does not meet the predetermined criteria set by the financial institution 130, the payment pooling system 136 reverts back to 330 to select additional customers for pooling. For example, the payment pooling system 136 (e.g., via the pool creation circuit 140) identifies parameters for additional customers needed for the pool to create a group of customers 110 having the desired characteristics. The parameters may specify the timing for various account surpluses and deficiencies in customer accounts that are needed for the pool. The payment pooling system 136 then selects new customers 110 that have financial data that meets the parameters, and repeats steps 340-380 until a group of customers 110 with the desired characteristics has registered that has the desired characteristics.

If the aggregate financial data of the customers 110 meets the predetermined criteria, a pooling arrangement is established amongst the registered customers 110 at 390. In some arrangements, to establish a payment pool, the payment pooling system 136 (e.g., via the pool creation circuit 140) creates an entry in the payment pooling database 148. The entry may identify a general pooling account to which funds in the pooling buffer accounts of the various customers 110 in the payment pool may be transferred to. Funds may be transferred from this general pooling account so that customers in the pool make timely payments to the service provider 120. The entry may also identify all of the customers 110 that are members of the pool and include customer financial account information (e.g., an account number for a general financial account held by each of the customers 110 at the financial institution 130 or a pooling buffer account).

It should be noted that alternative processes for the creation of pooling arrangements are envisioned. For example, in one alternative arrangement, the payment pooling system 136 may first identify a set of customers that stand to benefit from a pooling program. Similar to the pooling parameters discussed above in relation to step 230, the payment pooling system may assess account information in the customer financial account database 146 against predetermined criteria to determine if a particular customer 110 stands to benefit from the pooling program. In one example, the payment pooling system 136 identifies customers 110 that have made at least one late payment to the service provider 120 within a predetermined period but, on average, put more than enough money in their accounts to offset the total payments owed to the service provider 120.

Once the set of customers who stand to benefit from pooling has been identified, the payment pooling system 136 may transmit registration interfaces to the identified customers. In various arrangements, this is done through the same methodologies as discussed above in relation to step 340 of the method 300. In some arrangements, prior to transmitting registration interfaces to various customers 110, the payment pooling system 136 may retrieve content from the content database 150 and transmit the content to the customer computing devices 112. The transmitted content may identify alternative ways for the customer 110 to set aside funds to make timely payments to service provider 120 (e.g., a savings account program or the like). Additionally, the transmitted content may inform the customer 110 of a customer budget. For example, based on customer account balance information stored in the account database 146, the payment pooling system 136 may generate a suggested total payment amount that the customer 110 should make each month to the service provider 120.

Also like the method 300, customer registration information is received from the customers who indicated a preference to register for the payment pooling program after the registration interface is transmitted. After all the registration information has been received, the payment pooling system 136 may then perform steps 320 to 340 and select from amongst only customers that have registered in advance for the payment pooling program. This way, the steps 270-280 of the method 200 can be avoided prior to the establishing of the pooling arrangement at 290.

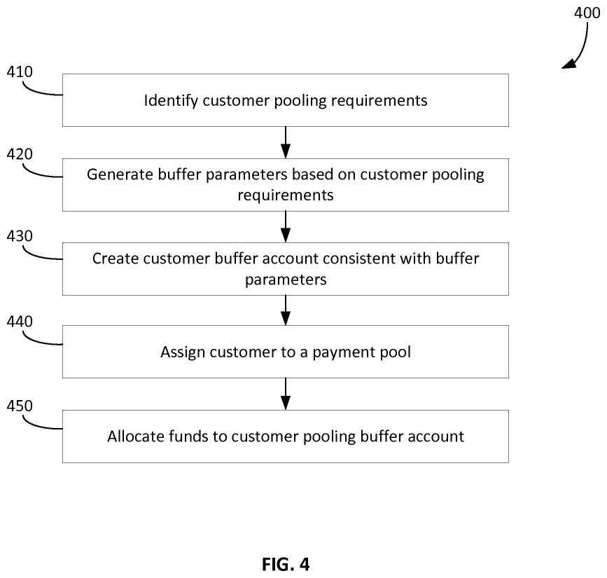

In various arrangements, once a payment pool is established, the payment pooling system 136 establishes pooling buffer accounts for each registered customer 110, transfers funds into each of the established pooling buffer accounts from various financial accounts of the registered customers, and transfers the funds in the pooling buffer accounts into the general pooling account so that the funds can be used to make upcoming payments owed by the registered customers 110 to the service provider 120. Each of these processes will be described in greater detail below with respect to FIGS. 4-6.

Referring now to FIG. 4, a flow diagram of a method 400 of assigning a particular customer 110 to a payment pool is described according to an example embedment. The method 400 may be performed by the components of FIG. 1, such that references may be made to one or more components of FIG. 1 to aid description of the method 400. It should be understood that initiation of the method 400 may take a variety of forms. In some arrangements, the method 400 may be initiated responsive to a customer 110 indicating a preference to register for a payment pooling program offered by the financial institution 130 (e.g., the financial institution computing system 132 receiving the customer's registration information at step 360 in the method 300 discussed above). In some arrangements, the method 400 may be initiated responsive to the payment pooling system 136 determining that a group of customers has registered for the payment pooling program that meets predetermined criteria set by the financial institution 130 (e.g., at the step 390 in the method 300 discussed above).

Customer pooling requirements are identified at 410. In some arrangements, where, for example, a payment profile has already been generated (e.g., using the methods discussed above) for a particular customer 110, this step includes identifying various characteristics of the payment profile of the customer 110 to determine customer pooling requirements. For example, the payment pooling system 136 (e.g., via the payment profile circuit 138) may determine the timing of customer account deficiencies, and identify the amount in payments that the customer account lacks funds to make. The payment pooling system 136 may also identify the total aggregate amount of payments owed by the customer 110 to the service provider 120 over the course of a predetermined period (e.g., a month).

In some arrangements, customer registration information received by the payment pooling system 136 (e.g., at step 360 in the method 300 discussed above) is used to update the payment profile generated for the customer. For example, in some arrangements, the registration interface transferred to the customer 110 (e.g., at step 350 in the method 300 discussed above) enables the customer 110 to input information pertaining to various payments owed by the customer 110 to service providers other than the service provider 120. For example, the registration interface may enable the customer 110 to identify the service providers to which the customer 110 owes payments, identify an amount of the owed payments, and a due date for the payments. In certain situations, the information input by the customer 110 into the registration interface may update the information stored in the customer financial account database 146. For example, the customer 110 may identify an additional service provider to which they owe a payment, or provide a due date that was not previously recognized by the payment pooling system 136. Accordingly, in these situations, the payment pooling system 136 is configured to update (e.g., via the payment profile circuit 138) the payment profile of the customer 110 to identify customer pooling requirements.

Buffer parameters are set for the customer 110 at 420. In various arrangements, the payment pooling system 136 is configured to generate parameters for a pooling buffer account based on the pooling requirements identified at 310. Buffer parameters may identify a threshold amount that the pooling buffer account of the customer 110 is to periodically reach (e.g., a maximal customer pooling buffer account balance that is to be reached each month by transferring funds from a financial account held by the customer 110 at the financial institution 130), a means through which customer funds are to be transferred into the customer pooling buffer account (e.g., a portion could be withdrawn from each direct deposit into a customer financial account or the customer may be sent a monthly billing statement), and a set of restrictions on the customer 110's access to funds placed in the pooling buffer account. In some arrangements, the threshold amount for the customer pooling buffer account is determined based on the total amount owed by the customer 110 to the service provider 120. For example, if a particular customer is projected to owe a total of $700 to the service provider 120 and other service providers over the course of a month, the payment pooling system 136 may set the customer buffer account threshold at $700. In this example, to continue to be eligible to participate in the payment pooling program, the customer 110 is required to make a monthly payment of $700 into a pooling buffer account.

In some arrangements, the way that the customer 110 places funds into the pooling buffer account is also set by the buffer parameters. The payment method may be determined through the registration process discussed above. For example, the registration requests transferred to the customer 110 for the payment pooling program (e.g., at step 350 in the method 300 discussed above) may enable the customer to indicate a pooling payment preference. The pooling payment preference may include several selectable options, such as a transfer from a customer financial account each month, a deduction from each direct deposit into the customer financial account, a monthly billing system, or the like. In some arrangements, only one payment method is available for customers 110 who participate in the payment pooling program. For example, the financial institution may set as a requirement that an automatic transfer from the customer financial account to the pooling buffer account be made each month.

In various arrangements, pooling buffer parameters also include restrictions on the customer 110's access to funds in the pooling buffer account. For example, in one embodiment, funds placed in the customer buffer account may only be used to make payments to the service provider 120 (and others). In other words, the customer 110 is not able to withdraw funds that are placed in the pooling buffer account. With such restrictions established, funds from pooling buffer accounts of other customers 110 may be placed into the customer pooling buffer account and used to make timely payments to the service provider 120 without running the risk that the customer 110 will withdraw the funds so as to make them unavailable for use in the payment methods to be described in greater detail below.

A customer buffer account is created at 430. In some arrangements, the payment pooling system 136 is configured to generate a pooling buffer account entry in the customer financial account database 146. In some arrangements, the pooling buffer account is a restricted portion in an existing financial account (e.g., a checking account) held by the customer 110 at the financial institution 130. In other arrangements, the pooling buffer account is a separate from any existing accounts held by the customer 110 at the financial institution 130. For example, the pooling buffer account may have a unique account number. Irrespective of the form that the pooling buffer account takes, it is stored in association with the customer 110 such that funds can be transferred by the customer 110 into the pooling buffer account from other various accounts held by the customer 110.

The customer 110 is assigned to a payment pool at 440. In some arrangements, if a general pooling account has already been established by the payment pooling system 136 in the payment pooling database 148, customer identifying information (e.g., a name, account identifying information, and the like), is stored in association with the general pooling account. In some arrangements, the payment pooling system 136 packages customer information with that of other customers 110 registered for the payment pooling program to create the general pooling account for the registered customers, as discussed above. In some arrangements, the information stored in the payment pooling database 148 includes various components of customer payment profiles such as a payment schedule detailing the due dates and amounts of payments owed by the customer 110 to the service provider 120.

Funds are allocated to customer pooling buffer account at 450. In various arrangements, the payment pooling system 136 is configured to transfer funds to the customer pooling buffer account from either the customer 110 with whom the pooling buffer account is associated (e.g., from a financial account of the customer 110), or from the general pooling account associated with the payment pool that the customer was assigned to at 440. The payment pooling system 136 is configured to transfer funds from the payment buffer account either to service provider 120 to which the customer 110 owes payments or to the general pooling account associated with the payment pool, so that the funds may be transferred to the pooling buffer accounts of other customers 110 in the payment pool to make other payments to the service provider 120.

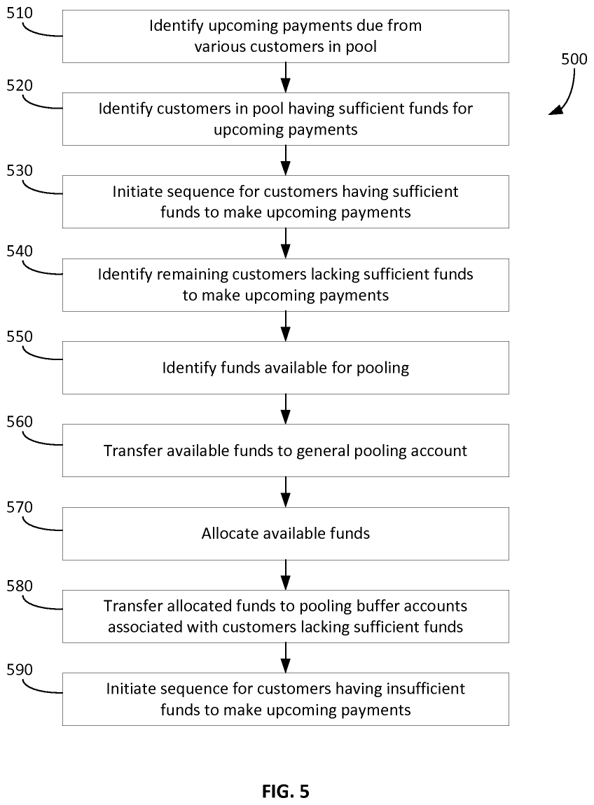

Referring now to FIG. 5, a flow diagram of a method 500 of allocating funds to customers 110 in a pool to make payments to the service provider 120 is shown according to an example embodiment. The method 500 may be performed by the components of FIG. 1, such that references may be made to one or more components of FIG. 1 to aid description of the method 500. It should be understood that initiation of the method 500 may take a variety of forms. For example, in various embodiments, the payment pooling system 136 (e.g., via the payment processing circuit 142) may periodically (e.g., daily) perform the method 500 once a payment pool amongst a selected group of customers 110 has been established (e.g., by the method 300 discussed above).

Upcoming payments owed by customers 110 are identified at 510. In various arrangements, the payment pooling system 136 (e.g., via the payment processing circuit 142) is configured to identify payments owed by the customers 110 included in a pooling arrangement that are due within a predefined period of time (e.g., that day, within the next week, etc.). In this regard, the payment pooling system 136 retrieves customer payment schedule information stored in the payment pooling database 148 and identifies upcoming due payments, and identifies the customers 110 associated with the upcoming payments.

Customers 110 with sufficient funds to make their upcoming payments are identified at 520. In some arrangements, the payment pooling system 136 (e.g., via the payment processing circuit 142) assesses the pooling buffer account balances for each of the customers 110 with upcoming payments identified at 510. The balance in each pooling buffer account may be compared to the total amount in payments that the customer 110 owes to the service provider 120 within a predetermined period. If the balance in the pooling buffer account for a particular customer 110 is greater than the total amount of payments owed by the customer 110, the customer 110 is deemed to have sufficient funds. Otherwise, the customer 110 is deemed to lack sufficient funds for upcoming payments.

A sequence is initiated for the customers having sufficient funds to make their upcoming payments at 530. In some arrangements, for each customer 110 deemed to have sufficient funds at 520, the payment pooling system 136 automatically transfers funds from the associated pooling buffer accounts to the service provider 120. For example, in one embodiment, the customer financial account database 146 includes information pertaining to customer accounts with the service provider 120. The information may include, for example, information that identifies the service provider 120, a customer account number, customer payment information (e.g., amounts and due dates), and the like. Using this information, the payment pooling system 136 is configured to deduct amounts from the pooling buffer account of the customer 110 that correspond to the identified upcoming payments and transfer the deducted amounts to the service provider 120. In other arrangements, the payment pooling system 136 transfers due-payment notifications to the customer 110, and directs the customer 110 to make the upcoming payments to the service provider 120. In such arrangements, a portion of the funds in the pooling buffer accounts of the customers 110 having sufficient funds for the upcoming payments is frozen (e.g., only accessible to make payments to service provider 120).

Remaining upcoming payments amongst customers 110 in the pool are identified at 540. In some arrangements, the payment pooling system 136 identifies the upcoming payments associated with the customers deemed to have insufficient funds at 520. The payment pooling system 136 identifies all upcoming payments associated with each of the identified customers 110 and determines their amounts and associated due dates.

Available pooling funds are identified at 550. In various arrangements, available pooling funds are derived from two sorts of customers 110 in the pool. The first group is the customers 110 that were deemed to have sufficient funds for their upcoming payments at 520. For each of those customers 110, an amount corresponding to the aggregate of the amount of upcoming payments was either transferred to or set aside for the service providers at 530. The amount of funds in the pooling buffer accounts for those customers above that was not set aside for the upcoming payments is thus available for pooling. The second group is the customers 110 in the pool identified as not having any upcoming payments owed to the service provider 120. Accordingly, for both of these groups of customers 110, the payment pooling system 136 is configured to identify an available balance in the pooling buffer accounts associated with the customers 110. The available funds are then transferred to the general pooling account associated with the pool at 560.

The available funds are allocated towards the upcoming due payments at 570. In various arrangements, to allocate the available funds, the payment pooling system 136 may engage in a two-step process. First, the amount of available funds is compared with the total amount of upcoming payments owed by the customers 110. Second, based on the comparison, the available funds are allocated towards the upcoming payments. If the amount of available funds is sufficient to make all of the upcoming payments, funds are transferred from the general pooling account to the pooling buffer accounts associated with the customers 110 lacking sufficient funds to make upcoming payments. Each customer 110 in need of funds is transferred an amount corresponding to the aggregate amount of upcoming payments owed by the customer 110. If the amount of available funds is insufficient to make all of the upcoming payments, then the funds are allocated amongst the customers 110 in need of funds to make their upcoming payments. In some arrangements, the portion of the allocated amount transferred to the pooling buffer account of each customer 110 in need of funds is proportional to the aggregate of upcoming payments owed by each customer. To illustrate, if a first customer has $300 in total payments due within the next week, a second customer has $500 in payments due within the next week, and a third customer has $200 in payments due within the next week, and only $500 was available to pool towards those customers, the first customer would receive $150, the second customer would receive $250, and the third customer would receive $100.

In some arrangements, rather than a customer-based allocation system, the payment processing circuit 142 allocates the funds using a payment-based system. In other words, an amount of funds is allocated towards each individual upcoming payment based on the amount of the upcoming payment. In such a system if a first customer owed two payments of $500 each while a second customer owed four payments of $300 each, the first customer may receive more of the available funds even though the first customer owes less in aggregate payments than the second customer because more of the available funds would be allocated towards each payment. As will be understood, the outcome of this example is dependent on various allocation parameters set by the financial institution 130.

In some arrangements, to allocate the available funds, the payment pooling system 136 may perform a payment-prioritization procedure. Payments being associated with the largest late fees may receive higher priority than those having smaller late fees. Accordingly, customers may receive a portion of the available funds that is dependent at least in part on the late fees associated with the upcoming payments. Alternatively or additionally, funds may be allocated towards upcoming payments based on the due dates of the upcoming payments.

Once allocated, the available funds are transferred from the general pooling account to the pooling buffer accounts associated with the customers 110 lacking sufficient funds to make their upcoming payments at 480. In various arrangements, the payment pooling system 136 updates the pooling buffer accounts in the financial institution accounts database 146 to reflect the amount of available funds allocated towards each customer.

A sequence is initiated to transfer funds from the pooling buffer accounts to the service provider 120 owed upcoming payments at 590. In some arrangements, the payment pooling system 136 is configured to automatically distribute funds from the pooling buffer account to the service provider 120. In the event that the pooling buffer account of a particular customer 110 lacks sufficient funds to make all of the upcoming payments, the payment pooling system 136 may transmit a notification to the customer 110 listing all of the upcoming payments owed by the customer and identifying an available balance in the customer 110's pooling buffer account. The notification may prompt the customer 110 to indicate a preference to provide the remaining necessary funds from the customer 110's primary account at the financial institution 130. For example, if a particular customer 110 has only $200 in the pooling buffer account after being allocated funds from the general pool and owes $500 in payments, the notification may provide the customer 110 with the ability to indicate a preference to deduct the remaining $300 from a checking account.

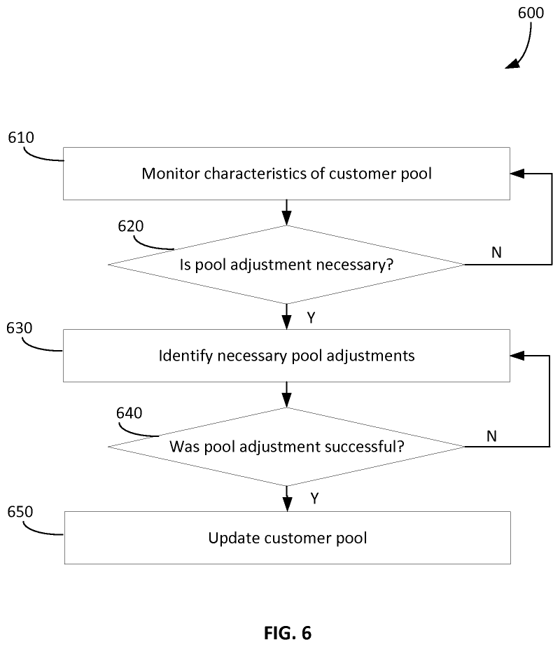

Referring now to FIG. 6, a flow diagram of a method 600 of updating a customer pool is shown according to an example embodiment. The method 600 may be performed by the components of FIG. 1, such that references may be made to one or more components of FIG. 1 to aid in the description of the method 600. It should be understood that initiation of the method 600 may take a variety of forms. For example, in various embodiments, the payment pooling system 136 (e.g., via the payment processing circuit 142) may periodically (e.g., daily) perform the method 600 once a payment pool amongst a selected group of customers 110 has been established (e.g., by the method 300 discussed above).

Characteristics of a customer pool are monitored at 610. In various arrangements, the payment pooling system 136 (e.g., via the pool monitoring circuit 144) receives information from various sources to monitor various aspects of a customer pool. One aspect of a customer pool that is monitored may be the relationships between the customers included in the pool and the service provider 120 and other service providers. In this regard, the payment pooling system 136 may receive information from customer computing device 112 or the service provider computing system 122 indicating a change in a customer relationship with a service provider 120. Additionally or alternatively, the customer 110 may change a relationship with a particular service provider (e.g., upgrade, discontinue, and the like) such that the amount in payments owed by the customer 110 to the service provider changes. Other customers may sign up for services with service providers other than the service provider 120, thereby increasing their total payment obligations.

Another aspect of a customer pool that may be monitored is customer financial account information. In this regard, the payment pooling system 136 may assess information in the customer financial account database 146 to determine whether any of the customers 110 have undergone any significant financial changes. For example, a particular customer 110, after being assigned to a particular payment pool, may begin receiving an alternative source of income being different in both amount and timing than the customer 110's previous source of income. Such a shift in income may cause the timing of customer account deficiencies and surpluses to change. Accordingly, the payment pooling system 136 is configured to identify such shifts based on changes in the customer 110's transaction history and catalogue any such changes to customers in a particular pool.

Yet another aspect of a customer pool that may be monitored is the pool registration status of various customers. In various arrangements, a customer may be able to unregister from the pooling program by indicating such a preference on the customer computing device 112. In some arrangements, a customer 110 may be automatically unregistered from the pooling program if the customer 110 fails to provide sufficient funds to a pooling buffer account. Accordingly, the payment pooling system 136 catalogues changes in the registration status of various pooling participants.

The necessity of a pool adjustment is determined at 620. In various arrangements, the payment pooling system 136 is configured to determine if any changes in customer circumstances warrant reconfiguration of the pooling arrangement. As discussed above, a particular pooling arrangement is established between a particular group of customers because the aggregate cash flow of the customers in that group meet predetermined criteria set by the financial institution 130. Assuming that a particular pooling arrangement is relatively large, a change in circumstances for a particular customer 110 should not dramatically impact the aggregate cash flows of the whole pool. However, if significant portion of the customers 110 in the pooling arrangement undergo significant changes in circumstances, the aggregate cash flows may change to enough of an extent that the predetermined criteria are no longer met. Accordingly, in some arrangements, the payment pooling system 136 is configured to update the payment pooling profiles of the customers 110 in the pool based on any circumstances recorded at 610. Based on these updated profiles, the payment pooling system 136 (e.g., through a process similar to that discussed above in relation to the step 380 of the method 300 discussed above) determines if the customers 100 in the pool still meet the predetermined criteria. If the customers still meet the criteria, then no pooling adjustment is necessary, and the payment pooling system 136 reverts back to 610 to continue to monitor characteristics of the customer pool.

If, however, it is determined that the customers in the pool no longer meet the predetermined criteria because of various changes in circumstances identified at 610, necessary pooling adjustments are identified at 630. Pooling adjustments may take a variety of forms. Certain pool adjustments may require an adjustment of the pooling requirements for a particular customer 110. For example, if the customer 110 changes the nature of a relationship with a particular service provider 120 such that the customer 110 owes more in payment to the service provider 120 than when the customer 110 was assigned to the pool, a particular pooling adjustment may be to update the required pooling buffer amount for that particular customer 110 (e.g., the customer 110 may be required to transfer more funds into a pooling buffer account each month or make payments at a greater frequency). In some examples, the payment pooling system 136 may identify certain payments owed by certain customers 110 as being incompatible with the pooling program. For example, if a particular customer 110 signed up for a new service from an additional service provider 120 and seeks to add the resulting payments to the payment pooling program, the payment pooling system 136 may prevent the customer 110 from doing so. In various arrangements, the payment pooling system 136 may notify the customer 110 of the implications of the customer 110's change in circumstances. Accordingly, the payment pooling system 136 may transmit a notification to the customer 110 identifying the required changes. In some arrangements, if the customer 110 refuses to make the identified changes, the customer 110 is removed from the payment pool.

Other pooling adjustments may include the registration of additional customers for the pooling arrangement (e.g., through the method 300 discussed above with respect to FIG. 3). For example, responsive to a subset of customers 110 in a pool being unregistered, the payment pooling system 136 may be configured to identify a deficiency in the aggregate cash flows of the customers 110 remaining in the pool. The deficiency may, for example, include the timing of a circumstance where the remaining customers 110 in the pool owe more in payments to the service provider 120 than the aggregate sum of all of the amounts in the various pooling buffer accounts associated with the pool. Given this deficiency, the payment pooling system 136 may assess financial account information of various customers 110 that are not registered for a pool to identify customers having financial information that serves to alleviate the identified efficiency ( e.g., customers 110 having an account surplus at the time of the pooling deficiency), and perform a registration process (e.g., similar to the steps 350-390 of the method 300 discussed above) for the identified customers 110. Such a process may be repeated until enough new customers register for the pool to alleviate the identified pooling deficiency.

In various arrangements, the payment pooling system 136 may prioritize one form of pooling adjustment over another. In one embodiment, prior to unregistering a particular customer or registering new customers, the payment pooling system 136 may seek to adjust the pooling requirements for identified customers already in the pool.

Accordingly, the payment pooling system 136 may determine if the prioritized pooling adjustment was successful at 640. For example, the payment pooling system 136 may determine if enough of the identified customers agreed to the updates identified at 630 (e.g., the customers agreed to provide more funds to a pooling buffer account) to maintain the existing pooling arrangement. If not enough of the identified customers agreed to the requested updates, the payment pooling system 136 may perform the procedures discussed above to register new customers to correct any persisting pooling deficiencies.

The customer pool is updated at 650. In various arrangements, the payment pooling system 136 stores the parameters of any changes made to the pool. For example, the identity of any customers added to the pool as well as any parameters associated with the added customers (e.g., pooling buffer amounts, payments owed to the service provider 120, and the like) may be stored in the payment pooling database 148. After the pool is updated, the payment pooling system 136 may continue to perform methods 600 and 600 continuously so that the customer in the pool make timely payments to the service provider 120.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure may be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A financial institution computing system associated with a financial institution, the system comprising:
a customer account database configured to retrievably store information pertaining to a plurality of financial accounts held by a plurality of customers of the financial institution; and
a processing circuit comprising a processor and memory, the memory structured to store instructions that are executable by the processor and cause the processing circuit to:
determine a risk score for a customer based at least in part on a variability of a funding level of a financial account of the customer, wherein the variability of the funding level of the financial account of the customer is determined based on:
determining a cash flow pattern of the financial account based on a transaction history retrieved from the customer account database; and
detecting variations in the cash flow pattern, the variations including at least one of a different payment amount or a different payment date;
identify a preexisting pooling group associated with a plurality of customers that have offsetting risk scores in a given time period, wherein the identification includes a determination that a predetermined risk score would not be exceeded by adding the customer to the preexisting pooling group;
determine that the customer is eligible for the preexisting pooling group associated with the plurality of customers based at least in part on the identification of the preexisting pooling group associated with the plurality of customers that have offsetting risk scores in the given time period;
transmit a plurality of interfaces to the customer, the plurality of interfaces including a registration interface and an input interface;
receive a plurality of inputs from the customer via the input interface, the inputs comprising a selection of designated reoccurring payments to include in the preexisting pooling group and a preference for an amount of funding to dedicate to a pooling buffer account;
responsive to the customer registering for the preexisting pooling group via the registration interface, create the pooling buffer account, the pooling buffer account associated with the financial account of the customer;
determine a funding amount for the pooling buffer account based on an amount of payments owed by the customer, the selection of designated reoccurring payments, and the preference for the amount of funding to dedicate to the pooling buffer account;
adjust the funding amount for the pooling buffer account in response to an additional input received from the customer via the input interface, the additional input enabling the customer to increase or decrease the funding amount for the pooling buffer account by a predetermined percentage;
transfer a first amount of funds from a subset of a plurality of financial accounts associated with a subset of the plurality of customers to the pooling buffer account, wherein the subset of the plurality of customers belong to the preexisting pooling group associated with the pooling buffer account, wherein the processing circuit is further caused to:
select the subset of the plurality of customers to create the preexisting pooling group, based on account balance information associated with the subset of the plurality of financial accounts; and
wherein the selection is determined, at least partially, by a payment profile circuit and is based on at least one of: a timing of a direct deposit made to at least one of the plurality of financial accounts, a timing of a payment owed by the plurality of customers to a third party, and an amount of the payment owed by the plurality of customers to a third party, such that the payment profile circuit is configured to determine whether there is a mismatch between when the plurality of customers has available funds and when the payment is due;
determine that the financial account associated with the customer has insufficient funds for a particular payment amount from the selection of designated reoccurring payments, the particular payment directed from the financial account to the third party; and
transfer a second amount of funds from the pooling buffer account based on the payment amount to the financial account associated with the customer.

2. (canceled)

3. (canceled)

4. (canceled)

5. The system of claim 1, wherein the processing circuit is further caused to generate a set of pooling buffer rules for the selected customer, the set of pooling buffer rules identifying a periodic amount to be transferred from the selected customer account to the pooling buffer account.

6. The system of claim 5, wherein the set of pooling buffer rules specify at least one restriction on the selected customer's access to funds in the pooling buffer account.

7. The system of claim 1, wherein the funds are transferred to a pooling account from the pooling buffer accounts associated with the subset of the plurality of customers belonging to the predetermined pooling group.

8. The system of claim 7, wherein the funds are transferred from the pooling account to the pooling buffer account associated with the customer.

9. The system of claim 7, wherein the processing circuit is further caused to:
determine a first total amount of funds that has been transferred from the pooling account to each of the pooling buffer accounts associated with each of the customers in the predetermined pooling group at the end of a first predetermined period;
determine a second total amount of funds that has been transferred to each of the pooling buffer accounts associated with each of the customers in the predetermined group from the pooling amount at the end of a second predetermined period; and
update the funding amount for at least one of the pooling buffer accounts associated with each of the plurality of customers in the predetermined pooling group based on the first and second total amounts of funds.

10. A method comprising:
determining, by a processor of a financial institution computing system associated with a financial institution, a risk score for a customer based at least in part on a variability of a funding level of a financial account of the customer, wherein the variability of the funding level of the financial account of the customer is determined based on:
determining a cash flow pattern of the financial account based on a transaction history retrieved from the customer account database; and
detecting variations in the cash flow patter, the variations comprising at least one of a different payment amount or a different payment date;
identifying, by the processor, a preexisting pooling group associated with a plurality of customers that have offsetting risk scores in a given time period, wherein the identification includes a determination that a predetermined risk score would not be exceeded by adding the customer to the preexisting pooling group;
determining, by the processor, that the customer is eligible for the preexisting pooling group associated with the plurality of customers based at least in part on the identification of the preexisting pooling group associated with the plurality of customers that have offsetting risk scores in the given time period;
transmitting, by the processor, a plurality of interfaces to the customer, the plurality of interfaces including a registration interface and an input interface;
receiving, by the processor, a plurality of inputs from the customer via the input interface, the inputs comprising a selection of designated reoccurring payments to include in the preexisting pooling group and a preference for an amount of funding to dedicate to a pooling buffer account;
responsive to the customer registering for the predetermined pooling group via the registration interface, creating, by the processor, the pooling buffer account, the pooling buffer account associated with the financial account of the customer;
determining, by the processor, a funding amount for the pooling buffer account based on an amount of payments owed by the customer, the selection of designated reoccurring payments, and the preference for the amount of funding to dedicate to the pooling buffer account;
adjusting, by the processor, the funding amount for the pooling buffer account in response to an additional input received from the customer via the input interface, the additional input enabling the customer to increase or decrease the funding amount for the pooling buffer account by a predetermined percentage;
transferring, by the processor, a first amount of funds from a plurality of financial accounts associated with a subset of the plurality of customers to the pooling buffer account, wherein the subset of the plurality of customers belong to the preexisting pooling group associated with the pooling buffer account, wherein the processing circuit is further caused to:
select the subset of the plurality of customers to create the preexisting pooling group, based on account balance information associated with the subset of the plurality of financial accounts; and
wherein the selection is determined, at least partially, by a payment profile circuit and is based on at least one of: a timing of a direct deposit made to at least one of the plurality of financial accounts, a timing of a payment owed by the plurality of customers to a third party, and an amount of the payment owed by the plurality of customers to a third party, such that the payment profile circuit is configured to determine whether there is a mismatch between when the plurality of customers has available funds and when the payment is due;
determining, by the processor, that the financial account associated with the customer has insufficient funds for a particular payment amount from the selection of designated reoccurring payments, the particular payment directed from the financial account to a third party; and
transferring, by the processor, a second amount of funds from the pooling buffer account based on the payment amount to the financial account associated with the customer.

11. (canceled)

12. (canceled)

13. (canceled)

14. The method of claim 10, further comprising generating, by the processor, a set of pooling buffer rules for the selected customer, the set of pooling buffer rules identifying a periodic amount to be transferred from the financial account associated with the selected customer to the pooling buffer account.

15. The method of claim 14, wherein the set of pooling buffer rules specify at least one restriction on the selected customer's access to funds in the pooling buffer account.

16. The method of claim 10, wherein the funds are transferred to a pooling account from the pooling buffer accounts associated with the plurality of customers belonging to the predetermined pooling group.

17. The method of claim 16, wherein the funds are transferred from the pooling account to the pooling buffer account associated with the customer.

18. A non-transitory computer readable media having computer-executable instructions embodied therein that, when executed by a processor of a financial institution computing system, causes the financial institution computing system to perform operations to transfer funds, the operations comprising:
determine a risk score for a customer based at least in part on a variability of a funding level of a financial account of the customer, wherein the variability of the funding level of the financial account of the customer is determined based on:
determining a cash flow pattern of the financial account based on a transaction history retrieved from the customer account database; and
detecting variations in the cash flow pattern, the variations comprising at least one of a different payment amount or a different payment date;
identify a preexisting pooling group associated with a plurality of customers that have offsetting risk scores in a given time period, wherein the identification includes a determination that a predetermined risk score would not be exceeded by adding the customer to the preexisting pooling group;
determine that the customer is eligible for the preexisting pooling group associated with the plurality of customers based at least in part on the identification of the preexisting pooling group associated with the plurality of customer that have offsetting risk scores in a given time period;
transmit a plurality of interfaces to the customer, the plurality of interfaces including a registration interface and an input interface;
receive a plurality of inputs from the customer via the input interface, the inputs comprising a selection of designated reoccurring payments to include in the preexisting pooling group and a preference for an amount of funding to dedicate to a pooling buffer account;
responsive to the customer registering for the preexisting pooling group via the registration interface, create the pooling buffer account, the pooling buffer account associated with the financial account of the customer;
determine a funding amount for the pooling buffer account based on an amount of payments owed by the customer, the selection of designated reoccurring payments, and the preference for the amount of funding to dedicate to the pooling buffer account;
adjust the funding amount for the pooling buffer account in response to an additional input received from the customer via the input interface, the additional input enabling the customer to increase or decrease the funding amount for the pooling buffer account by a predetermined percentage;
transfer a first amount of funds from a subset of a plurality of financial accounts associated with a subset of the plurality of customers to the pooling buffer account, wherein the subset of the plurality of customers belong to the preexisting pooling group associated with the pooling buffer account, wherein the processing circuit is further caused to:
select the subset of the plurality of customers to create the preexisting pooling group, based on account balance information associated with the subset of the plurality of financial accounts; and
wherein the selection is determined, at least partially, by a payment profile circuit and is based on at least one of: a timing of a direct deposit made to at least one of the plurality of financial accounts, a timing of a payment owed by the plurality of customers to a third party, and an amount of the payment owed by the plurality of customers to a third party, such that the payment profile circuit is configured to determine whether there is a mismatch between when the plurality of customers has available funds and when the payment is due;
determine that the financial account associated with the customer has insufficient funds for a particular payment amount from the selection of designated reoccurring payments, the particular payment directed from the financial account to a third party; and
transfer a second amount of funds from the pooling buffer account based on the payment amount to the financial account associated with the customer.

19. (canceled)

20. (canceled)

21. The system of claim 1, wherein the processing circuit is further caused to
monitor one or more characteristics of the preexisting pooling group, wherein the one or more characteristics comprise at least one of a change to an existing customer-provider relationship, a new customer-provider relationship, and a pool membership change;
determine, based on monitoring the one or more characteristics, a pool adjustment parameter comprising at least one of increasing the funding amount and decreasing the funding amount;
determine, based on the pool adjustment parameter and the one or more characteristics, whether the pool adjustment parameter is an incompatible parameter for the preexisting pooling group; and
perform one of operations comprising:
prevent, based on determining that the pool adjustment parameter is the incompatible parameter, the incompatible parameter from being adding to the preexisting pooling group; or
update, based on determining the pool adjustment parameter is not the incompatible parameter, the preexisting pooling group with the pool adjustment parameter.
